(19) United States
(12) Patent Application Publication
(10) Pub. No.: US 2024/0323759 A1
(43) Pub. Date: Sep. 26, 2024

(54) ELECTRONIC DEVICE INCLUDING PACKET PRE-PROCESSING CIRCUIT

(71) Applicant: SAMSUNG ELECTRONICS CO., LTD., Suwon-si (KR)

(72) Inventors: Seyong PARK, Suwon-si (KR); Byungseung KIM, Suwon-si (KR); Jonghan KIM, Suwon-si (KR); Hochong CHO, Suwon-si (KR)

(73) Assignee: SAMSUNG ELECTRONICS CO., LTD., Suwon-si (KR)

(21) Appl. No.: 18/612,649

(22) Filed: Mar. 21, 2024

(30) Foreign Application Priority Data
Mar. 21, 2023 (KR) 10-2023-0036892
Jul. 3, 2023 (KR) 10-2023-0085983

(51) Int. Cl. H04W 28/06; H04W 28/02; H04W 84/06

(52) U.S. Cl. CPC H04W 28/06; H04W 28/0221; H04W 84/06

(57) ABSTRACT

An electronic device includes a plurality of processors and a packet pre-processing circuit. The packet pre-processing circuit determines a pre-processing policy, from among a plurality of policies, for a packet transmitted from a first processor, among plurality of processors, to a second processor, among the plurality of the processors based on packet information related to the first processor and the second processor, and performs a pre-processing operation on the packet based on the determined pre-processing policy.

### CROSS-REFERENCE TO RELATED APPLICATION(S)

This application is based on and claims priority under 35 U.S.C. § 119 to Korean Patent Application No. 10-2023-0036892, filed on Mar. 21, 2023, and Korean Patent Application No. 10-2023-0085983, filed on Jul. 3, 2023, in the Korean Intellectual Property Office, the disclosures of which are incorporated by reference herein in their entireties.

### BACKGROUND

Embodiments of the disclosure relate to an electronic device, and more particularly, to a packet pre-processing circuit for transmitting packets between processors, and an electronic device including the packet pre-processing circuit.

As the use of electronic devices, such as smartphones, tablet personal computers (PCs), and smart watches becomes widespread, applications are being actively developed to provide various services to users. The electronic devices include a plurality of processors to execute the applications, and the plurality of processors may generate a plurality of packets based on the executed applications and transmit the plurality of packets to destination processors. However, a source processor of packets transmits the packets without considering the state of a destination processor of packets, and this may cause inefficient power consumption or inefficient use of wireless resources on the destination processor of packets. For example, when a destination processor is in a power saving mode (or an idle state), the destination processor wakes up to receive packets that are not urgent or important, resulting in power consumption. In another example, when wireless resources for wireless communication are scarce, the number of transmissions has to be minimized and the amount of transmission per transmission has to be increased. However, when a packet is received by a processor without considering the above situation, the processor responds and transmits a data signal corresponding to the packet to another electronic device using wireless resources, and this may result in inefficient use of wireless resources.

### SUMMARY

Embodiments of the disclosure provide a packet pre-processing circuit and an electronic device including the pre-processing circuit. The packet pre-processing circuit may determine one or more pre-processing policies for the packets to minimize unnecessary power consumption or effectively use wireless resources by considering states of processors, the importance of applications corresponding to packets, a network, or the like when transmitting and receiving the packets between the processors included in the electronic device. The pre-processing circuit may pre-processes the packets based on determined pre-processing policies.

According to an aspect of the disclosure, there is provided an electronic device including: a plurality of processors; and a packet pre-processing circuit configured to: determine a pre-processing policy, from among a plurality of policies, for a packet transmitted from a first processor, among plurality of processors, to a second processor, among the plurality of the processors based on packet information related to the first processor and the second processor, and perform a pre-processing operation on the packet based on the determined pre-processing policy.

According to another aspect of the disclosure, there is provided a first electronic device including: a communication processor configured to perform data processing for communication with a second electronic device based on a network established between the first electronic device and the second electronic device; an application processor configured to transmit a first packet, which is generated based on a first application, to the communication processor; and a packet pre-processing circuit configured to: determine a first pre-processing policy for the first packet based on an importance level of the first application and a state of the communication processor, and perform a pre-processing operation on the first packet based on the determined first pre-processing policy.

According to another aspect of the disclosure, there is provided an electronic device including: a plurality of intellectual properties (IPs); and a packet pre-processing circuit configured to perform a pre-processing operation on a packet that is transmitted from a first IP, among the plurality of IPs to a second IP, among the plurality of IPs based on packet information related to at least one of the first IP and the second IP, wherein the pre-processing operation includes one of a delay transmission operation, a proxy transmission operation, and a packet drop operation.

### BRIEF DESCRIPTION OF DRAWINGS

Embodiments will be more clearly understood from the following detailed description taken in conjunction with the accompanying drawings in which:

FIG. 1 is a block diagram schematically illustrating a network system according to an embodiment;

FIG. 2 is a flowchart for explaining a method of operating a packet pre-processing circuit, according to an embodiment;

FIGS. 3A to 3D are views for explaining first to fourth policies, respectively, which may be determined as pre-processing policies according to an embodiment;

FIG. 4 is a diagram for explaining packet information according to an embodiment;

FIG. 5A is a flowchart for explaining a method of storing first-type information in a packet pre-processing circuit according to an embodiment and FIG. 5B is a flowchart for explaining a method of updating the first-type information in a packet pre-processing circuit according to an embodiment;

FIG. 6A is a flowchart for explaining a method of storing second-type information in a packet pre-processing circuit in a packet pre-processing circuit and FIG. 6B is a flowchart for explaining a method of updating the second-type information in a packet pre-processing circuit according to an embodiment;

FIG. 7 is a diagram for explaining packet information according to an embodiment;

FIG. 8 is a flowchart for explaining a method of operating a packet pre-processing circuit, according to an embodiment;

FIG. 9 is a flowchart for explaining a method of operating a packet pre-processing circuit in operation S650 of FIG. 8;

FIG. 10A is a flowchart for explaining a method of operating a packet pre-processing circuit in operation S654 of FIG. 9, and FIG. 10B is a table in which information referenced in an embodiment of FIG. 10A is listed.

FIG. 11 is a flowchart for explaining a method of operating a packet pre-processing circuit in operation S655 of FIG. 9;

FIG. 12 is a flowchart for explaining a method of operating a packet pre-processing circuit in operation S660 of FIG. 8;

FIG. 13 is a flowchart for explaining a method of operating a packet pre-processing circuit in operation S662 of FIG. 12;

FIG. 14 is a flowchart for explaining a method of operating a packet pre-processing circuit, according to an embodiment;

FIG. 15 is a block diagram schematically illustrating a mobile application processor (AP) according to an embodiment; and

FIG. 16 is a view showing examples of devices for wireless communication according to an embodiment.

### DETAILED DESCRIPTION

Hereinafter, embodiments will be described in detail with reference to the accompanying drawings.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the disclosure, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment (e.g., as to what an example or embodiment may include or implement) means that at least one example or embodiment exists where such a feature is included or implemented, while all example embodiments are not limited thereto.

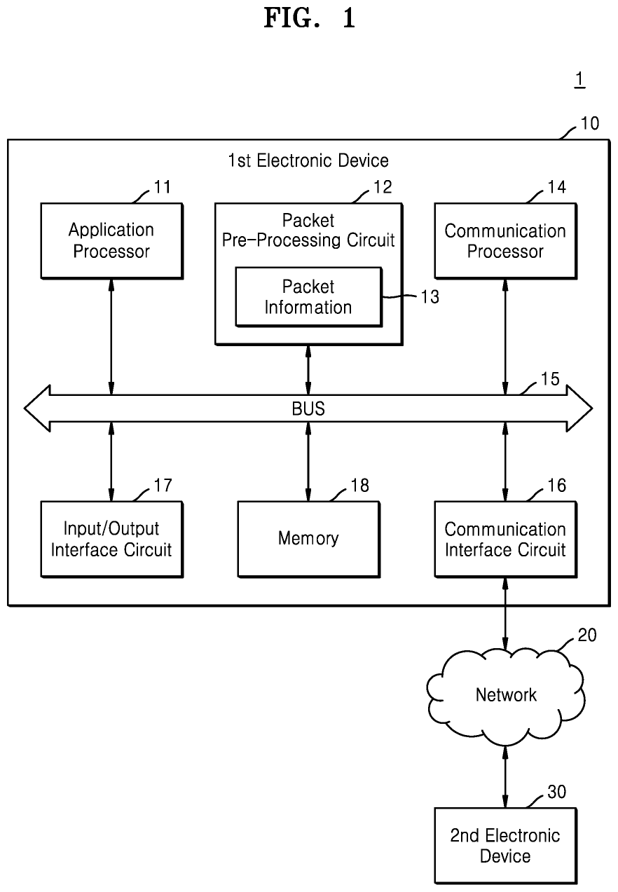

FIG. 1 is a block diagram schematically illustrating a network system 1 according to an embodiment.

Referring to FIG. 1, the network system 1 may include a first electronic device 10 and a second electronic device 30. The first electronic device 10 and the second electronic device 30 may be connected to a network 20 via wireless communication or wired communication, and the first electronic device 10 and the second electronic device 30 may communicate with each other.

In an embodiment, the first electronic device 10 and/or the second electronic device 30 may include at least one of smartphones, tablet personal computers (PCs), mobile phones, video phones, e-book readers, desktop PCs, laptop PCs, netbook computers, workstations, servers, personal digital assistants (PDAs), portable multimedia players (PMPs), medical devices, cameras, and wearable devices. A wearable device may include at least one of an accessory-type circuit, a fabric or clothing embedded-type circuit, a body attached-type circuit, and a bioimplant-type circuit. According to an embodiment, the first electronic device 10 and/or the second electronic device 30 may include at least one of televisions, digital video disk (DVD) players, audio systems, refrigerators, air conditioners, vacuum cleaners, ovens, microwaves, washing machines, air purifiers, set-top boxes, home automation control panels, security control panels, media boxes, game consoles, electronic dictionaries, electronic keys, camcorders, and electronic picture frames. However, the disclosure is not limited thereto, and as such, first electronic device 10 and/or the second electronic device 30 may include any other types of electronic device.

For example, the first electronic device 10 and the second electronic device 30 may include at least one of various medical devices, navigation devices, satellite navigation systems, event data recorders (EDRs), flight data recorders (FDRs), automotive infotainment devices, marine electronic devices, avionics, security devices, vehicle head units, industrial or home robots, drones, automated teller machines (ATMs) in financial institutions, point of sales (POSs) in stores, and Internet of Things devices.

In an embodiment, the first electronic device 10 may include an application processor 11, a packet pre-processing circuit 12, a communication processor 14, a bus 15, a communication interface circuit 16, an input/output interface circuit 17, and memory 18. As used herein, the application processor 11 may be referred to as AP and the communication processor 14 may be referred to as CP.

The application processor 11 may execute a plurality of applications to control a plurality of hardware or software components connected to the application processor 11 or may perform various data processing operations and calculations. As used herein, an application may be referred to as an application program. For example, the application processor 11 may communicate with the second electronic device 30 and execute a plurality of applications that provide services to a user based on the communication results. However, the disclosure is not limited thereto, and as such, the application may be referred to as “apps” or “application software”. The application processor 11 may transmit packets, which are generated by executing the plurality of applications, to the communication processor 14 or process packets received from the communication processor 14. That is, the application processor 11 may transmit and receive packets and process packets in conjunction with the communication processor 14 in order to provide services to the user based on a plurality of applications. However, although FIG. 1 mainly shows a pre-processing operation for packets transmitted and received between the application processor 11 and the communication processor 14, this is only an example and the embodiment is not limited thereto. For example, the pre-processing operation according to the disclosure may also be performed on packets transmitted and received between different types of processors or on packets transmitted and received between different types of intellectual properties (IPs) (e.g., main IP and auxiliary IP).

In an embodiment, the packet pre-processing circuit 12 may perform a pre-processing operation on packets transmitted and received between the application processor 11 and the communication processor 14. As used herein, the packet pre-processing circuit 12 may also be referred to as a bidirectional packet pre-processing circuit. The packet pre-processing circuit 12 may serve as an interface that routes bidirectional packets between the application processor 11 and the communication processor 14.

In an embodiment, the packet pre-processing circuit 12 may determine a pre-processing policy for preventing unnecessary power consumption by the application processor 11 or the communication processor 14 based on packet information 13. Also, the packet pre-processing circuit 12 may perform a pre-processing operation on packets based on the determined pre-processing policy. However, the disclosure is not limited thereto, and as such, according to another embodiment, the packet pre-processing circuit 12 may determine a pre-processing policy based one or more other criteria. For example, the packet pre-processing circuit 12 may determine a pre-processing policy for effectively using wireless resources of the network 20 based on the packet information 13 and may perform pre-processing operations on packets based on the determined pre-processing policy.

In an embodiment, the wireless communication using the network 20 between the first electronic device 10 and the second electronic device 30 may include, but is not limited to, cellular communication that uses at least one of long term evolution (LTE), LTE-Advanced (LTE-A), new radio (NR), code division multiple access (CDMA), wideband CDMA (WCDMA), universal mobile telecommunications system (UMTS), wireless broadband (WiBro), and global system for mobile communications (GSM). According to an embodiment, the wireless communication may include, but is not limited to, at least one of wireless fidelity (WiFi), Bluetooth, Bluetooth low energy, Zigbee, near field communication (NFC), magnetic secure transmission, radio frequency (RF), and body area network (BAN). Also, the wireless communication may include satellite communication and global navigation satellite system (GNSS). The GNSS may include, for example, a global positioning system (GPS), a global navigation satellite system (Glonass), a BeiDou navigation satellite system, and the European global satellite-based navigation system (that is, Galileo). The wired communication may include, but is not limited to, at least one of a universal serial bus (USB), a high definition multimedia interface (HDMI), a recommended standard 232 (RS-232), power line communication, and a plain old telephone service (POTS).

In an embodiment, the packet information 13 may include information related to the application and communication processors 11 and 14 or packets, and this information may be referenced by the packet pre-processing circuit 12 to determine the pre-processing policy for the packets. For example, the packet information 13 may include first-type information collected from the application processor 11 and second-type information collected from the communication processor 14. In an embodiment, the packet pre-processing circuit 12 may collect the first-type information by directly accessing the application processor 11 or by accessing a memory region in which the information managed by the application processor 11 is stored. Also, in an embodiment, the packet pre-processing circuit 12 may collect the second-type information from information provided from the communication processor 14.

In an embodiment, the packet pre-processing circuit 12 may determine, as a pre-processing policy, either a policy for delaying packet scheduling or a policy for adjusting the amount of packet transmission to a lower level based on the packet information 13.

In an embodiment, the packet pre-processing circuit 12 may determine one of the plurality of policies as the pre-processing policy for the packet, which is received from the application processor 11 or the communication processor 14, based on the packet information 13 and may perform the pre-processing operation on the packet based on the determined pre-processing operation.

In an embodiment, the plurality of policies may include a first policy for bypassing a packet, which is received by the packet pre-processing circuit 12, to a destination for the packet, a second policy for delay-transmitting a packet, which is received by the packet pre-processing circuit 12, to a destination of the packet, a third policy in which the packet pre-processing circuit 12 proxy-transmits a response with respect to a packet on behalf of a destination of the packet, and a fourth policy in which the packet pre-processing circuit 12 drops a packet. According to an embodiment of the disclosure, the second policy may correspond to an example of the above-described policy for delaying packet scheduling, and the third and fourth policies may correspond to an example of the above-described policy for adjusting the amount of packet transmission to a lower level.

In an embodiment, the packet pre-processing circuit 12 may determine which of the first to fourth policies the received packet corresponds to the packet information 13 and may determine the most appropriate policy for the received packet as a pre-processing policy.

In an embodiment, the packet pre-processing circuit 12 may perform a pre-processing operation on a first packet that is transmitted through an uplink formed from the application processor 11 to the communication processor 14 and may perform a pre-processing operation on a second packet that is transmitted through a downlink formed from the communication processor 14 to the application processor 11. In other words, the packet pre-processing circuit 12 may perform certain operations on the packets bidirectionally transmitted via the uplink and downlink.

For example, the packet pre-processing circuit 12 may check the importance of an application corresponding to the first packet and a state of the communication processor 14 from the packet information 13, determine whether power saving for the communication processor 14 is required based on the importance and state described above, determine a first pre-processing policy for the first packet based on the determined result, and perform a pre-processing operation on the first packet based on the determined first pre-processing policy. According to an embodiment, the importance may be one of a plurality of categories, such as, low, medium or high.

For example, when the importance of the application corresponding to the first packet is low and the communication processor 14 operates in a power saving mode (or an idle state), the packet pre-processing circuit 12 may pre-process the first packet such that the communication processor 14 does not wake up from the power saving mode (or the idle state) to a normal mode (or an operating state). For example, the packet pre-processing circuit 12 may determine the second policy as the pre-processing policy for the first packet and delay the first packet and transmit the first packet to the communication processor 14 so that the communication processor 14 remains in the power saving mode (or the idle state) as long as possible. In another example, the packet pre-processing circuit 12 may determine the third policy as the pre-processing policy for the first packet and may generate a response with respect to the first packet and transmit the generated response to the application processor 11 on behalf of the communication processor 14 so that the communication processor 14 remains in the power saving mode (or idle state) as long as possible. In another example, the packet pre-processing circuit 12 may determine the fourth policy as the pre-processing policy for the first packet and may drop the first packet so that the communication processor 14 remains in the power saving mode (or the idle state) as long as possible.

For example, the packet pre-processing circuit 12 may check the importance of an application corresponding to the second packet and a state of the application processor 11 from the packet information 13, determine whether power saving for the application processor 11 is required based on the importance and state described above, determine a second pre-processing policy for the second packet based on the determined result, and perform a pre-processing operation on the second packet based on the determined second pre-processing policy.

For example, in a case in which the importance of the application corresponding to the second packet is low and the application processor 11 operates in a power saving mode (or an idle state), the packet pre-processing circuit 12 may pre-process the second packet such that the application processor 11 does not wake up from the power saving mode (or the idle state) to a normal mode (or an operating state).

However, the disclosure is not limited thereto, and as such, a level of importance (or “importance level”) may be indicated in another manner. For example, the importance level may be represented as a numerical value. For example, an importance level may be set in a range of 1 to 5, where an importance level of 1 may be very low, an importance level of 2 may be low, an importance level of 3 may be very medium, an importance level of 4 may be high, and an importance level of 1 may be very high. However, the disclosure is not limited to a numerical range of 1-5, and as such another range or another form of labeling the importance level may be used. In another embodiment, the importance information may include priority information associated with an application or an application processor executing the application. The importance level may also indicate an urgency of the packet.

Also, for example, the packet pre-processing circuit 12 may check, from the packet information 13, whether the network 20 corresponding to the first packet is related to satellite communication and may determine the first pre-processing policy for the first packet based on the checked result and perform a pre-processing operation for the first packet based on the determined first pre-processing policy.

For example, in a case in which the network 20 corresponding to the first packet relates to the satellite communication, the packet pre-processing circuit 12 may determine the second policy as the first pre-processing policy for the first packet and may delay the first packet and then transmit the first packet to the communication processor 14 so that the communication processor 14 transmits packets to the second electronic device 30 as intensively as possible in a specific section.

In an embodiment, the bus 15 may connect the application processor 11, the packet pre-processing circuit 12, the communication processor 14, the input/output interface circuit 17, and the memory 18 to each other in the first electronic device 10 and may include circuits for internal communication between the application processor 11, the packet pre-processing circuit 12, the communication processor 14, the input/output interface circuit 17, and the memory 18. In particular, the bus 15 may transmit packets to the application processor 11, the packet pre-processing circuit 12, and the communication processor 14.

In an embodiment, the communication interface circuit 16 may be connected to the network 20 via wireless or wired communication so as to communicate with the second electronic device 30. For example, the communication interface circuit 16 may transmit data, which is received from the second electronic device 30, to the communication processor 14. The communication processor 14 may process the received data to generate packets and may transmit the generated packets to the packet pre-processing circuit 12 with the application processor 11 as a destination processor. In another example, the communication interface circuit 16 may transmit the data, which is received from the communication processor 14, to the second electronic device 30 via the network 20.

In an embodiment, the memory 18 may include volatile or non-volatile memory. The memory 18 may store commands or programs associated with the application processor 11 or communication processor 14. In addition, the memory 18 may store the packet information 13 used by the packet pre-processing circuit 12.

Also, in an embodiment, the packet pre-processing circuit 12 may be provided as hardware that is separated from the application processor 11 and the communication processor 14. According to an embodiment, the packet pre-processing circuit 12 may be provided as software or hardware that is integrated with the communication processor 14. In an example case in which the packet pre-processing circuit 12 is provided as software, the commands or programs related to the packet pre-processing circuit 12 may be stored in the memory 18. Also, the operation of the packet pre-processing circuit 12 may be performed as the communication processor 14 executes the corresponding command or program stored in the memory 18.

In an embodiment, the input/output interface circuit 17 may receive an input from a user or another external device or may transmit an output generated by the first electronic device 10 to the user or another external device.

In an embodiment, the first electronic device 10 and the second electronic device 30 may be the same or different types of devices. Also, the technical idea of the disclosure described in the first electronic device 10 may also be applied to the second electronic device 30.

The packet pre-processing circuit 12 according to an embodiment may adaptively determine a pre-processing policy for packets, which are transmitted and received between the application processor 11 and the communication processor 14, based on the packet information 13. Accordingly, it is possible to prevent unnecessary power consumption or inefficient use of wireless resources. As a result, the overall performance of the first electronic device 10 may be improved.

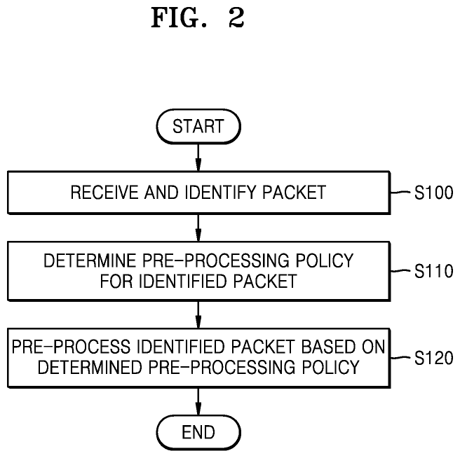

FIG. 2 is a flowchart for explaining a method of operating a packet pre-processing circuit according to an embodiment.

Referring to FIG. 2, according to an embodiment, in operation S100, the method may include receiving a packet and identifying the received packet. For example, the packet pre-processing circuit may receive a packet and identify the received packet. In an embodiment, the packet pre-processing circuit may check a session corresponding to the received packet, based on the packet information, and may identify the received packet. In an example case in which the packet is based on a user datagram protocol (UDP), a session corresponding to the packet may be defined as a set of a port number to which the packet is transmitted, a remote internet protocol (IP) address, and an IP address of an application processor related to the packet. In another example case in which the packet is based on a transmission control protocol (TCP), a session corresponding to the packet may be defined as a set of port number, an IP address, and a TCP session state.

According to an embodiment, in operation S110, the method may include determining a pre-processing policy for the identified packet. For example, the packet pre-processing circuit may determine a pre-processing policy for the packet, which has been identified in operation S100. In an embodiment, the packet pre-processing circuit may determine one of a plurality of policies as a pre-processing policy for the identified packet, based on the packet information. In a specific example, the packet pre-processing circuit may check the importance of an application corresponding to the identified packet and the state of a processor that is a destination processor of the identified packet, based on the packet information. The packet pre-processing circuit determines that power saving is required, when the importance of the application is low and the destination processor operates in a power saving mode. Accordingly, the packet pre-processing circuit may determine a pre-processing policy for power saving. According to another example, the packet pre-processing circuit may check, from the packet information, whether a network corresponding to the identified packet corresponds to a specific network. According to an embodiment of the disclosure, the specific network includes a network in an environment in which wireless resources are scarce and may correspond to a network related to, for example, satellite communication. The packet pre-processing circuit may determine a pre-processing policy for efficient use of wireless resources, in an example case in which the network corresponding to the identified packet is associated with the satellite communication.

According to an embodiment, in operation S120, the method may include pre-processing the identified packet based on the pre-processing policy. For example, the packet pre-processing circuit may pre-process the identified packet based on the pre-processing policy determined in operation S110. For example, the determined pre-processing policies may include at least one of a first policy of bypassing the identified packet to the destination processor, a second policy of delay-transmitting the identified packet to the destination processor, a third policy of transmitting a response with respect to the identified packet on behalf of the destination processor, and a fourth policy of dropping the identified packet. According to an embodiment of the disclosure, the first policy may be referred to as a policy for normal transmission.

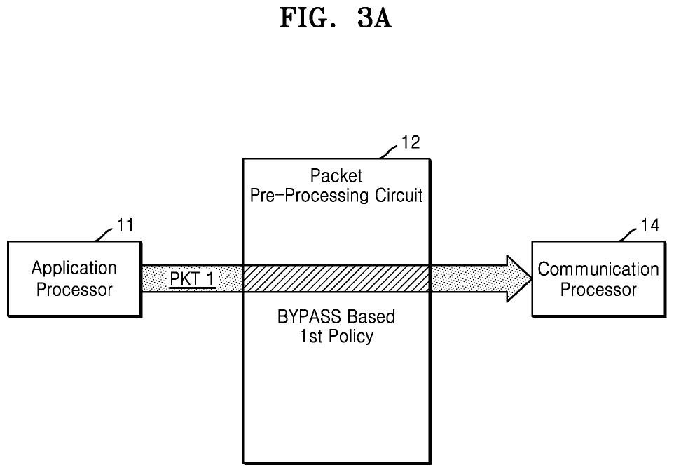

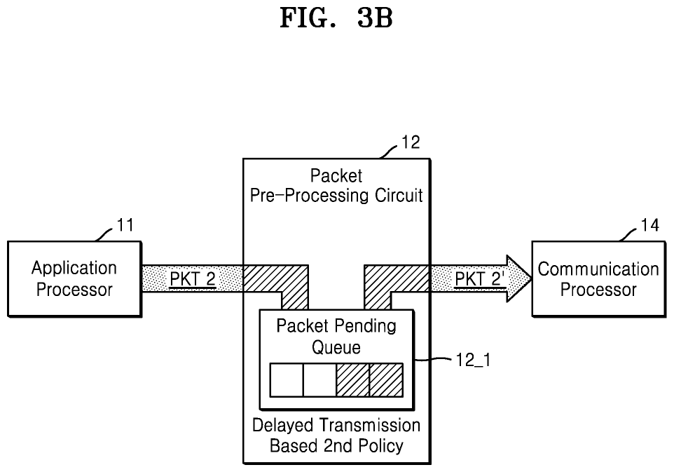

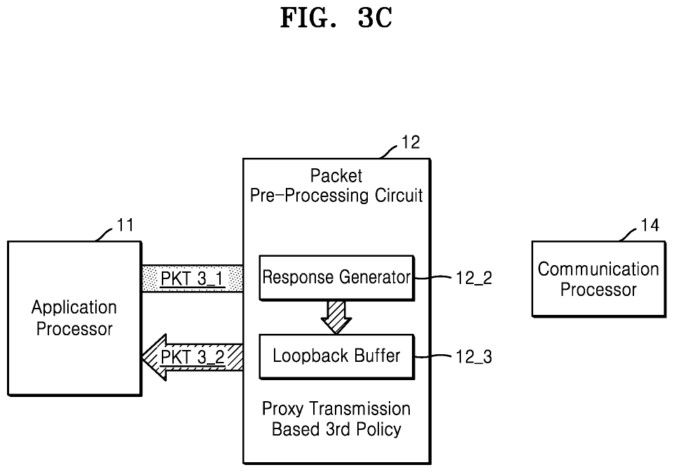

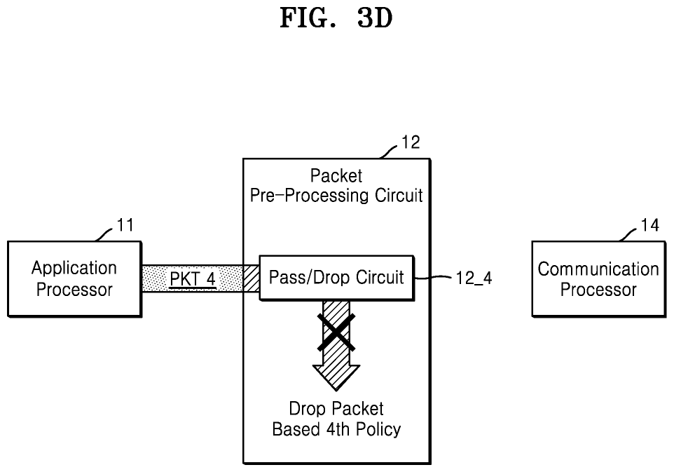

FIGS. 3A to 3D are views for explaining first to fourth policies, respectively, which may be determined as pre-processing policies according to an embodiment. FIG. 3A to 3D illustrate embodiments that focus on an uplink packet in which a source processor is the application processor 11 and a destination processor is the communication processor 14. Also, it may be fully understood that the above embodiments are also applied to a downlink packet in which a source processor is the communication processor 14 and a destination processor is the application processor 11.

Referring to FIG. 3A, the application processor 11 may transmit a first packet PKT_1, for which a destination processor is the communication processor 14, to the packet pre-processing circuit 12. In a case in which the packet pre-processing circuit 12 determines the first policy as the pre-processing policy for the first packet PKT_1, the packet pre-processing circuit 12 may bypass the first packet PKT_1 and transmit the first packet PKT_1 to the communication processor 14. For example, the packet pre-processing circuit 12 may perform the bypass by transmitting the first packet PKT_1 to the destination processor (e.g., the communication processor 14) without performing any preprocessing operation on the first packet PKT_1. That is, the first packet PKT_1 may bypass a packet pre-processing operation performed by the packet pre-processing circuit 12. The packet pre-processing circuit 12 may normally bypass the first packet PKT_1 when power saving for the communication processor 14 is not required or when the network is not in a situation in which wireless resources are scarce.

Referring further to FIG. 3B, the application processor 11 may transmit a second packet PKT_2, for which a destination processor is the communication processor 14, to the packet pre-processing circuit 12. In a case in which the packet pre-processing circuit 12 determines the second packet PKT_2, the packet pre-processing circuit 12 may store the second packet PKT_2 in a packet pending queue 12_1 provided in the packet pre-processing circuit 12 and may then transmit a second packet PKT_2′ stored in the packet pending queue 12_1 to the communication processor 14 after a certain delay time has elapsed. In an embodiment, the packet pre-processing circuit 12 may include a plurality of packet pending queues, and the plurality of packet pending queues may be assigned to sessions different from each other. For example, when a plurality of sessions are formed by one application, a number of packet pending queues corresponding to the sessions may be managed by the packet pre-processing circuit 12.

In an embodiment, the packet pre-processing circuit 12 may determine the delay time for the second packet PKT_2 based on the packet information. In a specific example, the packet pre-processing circuit 12 may check, based on the packet information, the maximum possible delay time, which is preset for the application of the second packet PKT_2, and a timer of the power saving mode (or the idle state) of the communication processor 14 and may determine the delay time considering the corresponding timer within the maximum possible delay time. In another specific example, the packet pre-processing circuit 12 may check, from the packet information, information about a section, in which the communication processor 14 intensively uses wireless resources, and may determine the delay time based on this information.

Referring further to FIG. 3C, the application processor 11 may transmit a third packet PKT_3_1, for which a destination processor is the communication processor 14, to the packet pre-processing circuit 12. In a case in which the packet pre-processing circuit 12 determines the third policy as the pre-processing policy for the third packet PKT_3_1, a response generator 12_2 provided in the packet pre-processing circuit 12 may generate a response packet PKT_3_2 for the third packet PKT_3_1 and store the response packet PKT_3_2 in a loopback buffer 12_3 provided in the packet pre-processing circuit 12. Subsequently, the packet pre-processing circuit 12 may transmit the response packet PKT_3_2 stored in the loopback buffer 12_3 to the application processor 11 on behalf of the communication processor 14.

In an embodiment, the response generator 12_2 may generate the response packet PKT_3_2 using information contained in the packet information. For example, when the third packet PKT_3_1 includes a ‘TCP keepalive’ packet for repeatedly requesting an IP address as a domain name system (DNS) query, the response generator 12_2 may check a valid IP address obtained by a previous DNS query from the packet information and generate the response packet PKT_3_2 based on the valid IP address.

In another example, if a state of a current TCP session is in a ‘finish (fin)’ state or ‘reset (rst)’ state and the application processor 11 is in a power saving mode (or an idle state), when the packet pre-processing circuit 12 receives a packet from the communication processor 14, the response generator 12_2 may generate an ‘rst’ packet (or a response packet) on behalf of the application processor 11 and then proxy-transmit this packet to the communication processor 14. This embodiment shows an example in which the packet pre-processing circuit 12 transmits a response packet to the communication processor 14 on behalf of the application processor 11. According to an embodiment, the response generator 12_2 may be provided as a transmission control protocol/internet protocol (TCP/IP) stack.

In an embodiment, the packet pre-processing circuit 12 may accumulate, as a history related to proxy transmission, the transmission of the response packet PKT_3_2 on behalf of the communication processor 14 and may provide the corresponding history to the communication processor 14 when necessary.

Referring further to FIG. 3D, the application processor 11 may transmit a fourth packet PKT_4, for which a destination processor is the communication processor 14, to the packet pre-processing circuit 12. In a case in which the packet pre-processing circuit 12 determines the fourth policy as the pre-processing policy for the fourth packet PKT_4, a pass/drop circuit 12_4 provided in the packet pre-processing circuit 12 may drop the fourth packet PKT_4.

In an embodiment, when the fourth packet PKT_4 includes a TCP-based packet scheduled for retransmission, the packet pre-processing circuit 12 may use the fourth policy as a pre-processing policy for the fourth packet PKT_4. In a case in which the fourth packet PKT_4 includes a UDP-based packet for which retransmission is not scheduled, the fourth policy may not be utilized. That is, the packet pre-processing circuit 12 may determine the fourth policy as the pre-processing policy only for packets scheduled to be retransmitted. These embodiments may be intended for the packet pre-processing circuit 12 to minimize side effects caused by packet dropping.

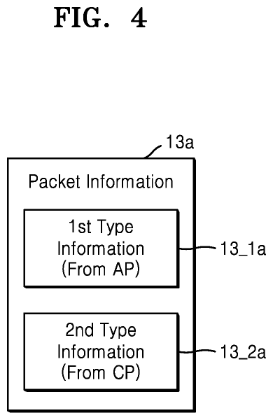

FIG. 4 is a diagram for explaining packet information 13a according to an embodiment.

Referring to FIG. 4, the packet information 13a may include first-type information 13_1a and second-type information 13_2a. The first-type information 13_1a and the second-type information 13_2a may be related to information managed by different entities. For example, the first-type information 13_1a may include information collected from an application processor AP and the second-type information 13_2a may include information collected from a communication processor CP.

In an embodiment, the packet pre-processing circuit may collect the first-type information 13_1a by directly accessing the application processor AP or by accessing a memory region in which the information managed by the application processor AP is stored. In addition, the packet pre-processing circuit may receive the second-type information 13_2a from the communication processor CP or may generate the second-type information 13_2a by accessing a memory region in which the information managed by the communication processor CP is stored.

In an embodiment, when determining a pre-processing policy for the received packet, the packet pre-processing circuit may use at least one of the first-type information 13_1a and the second-type information 13_2a.

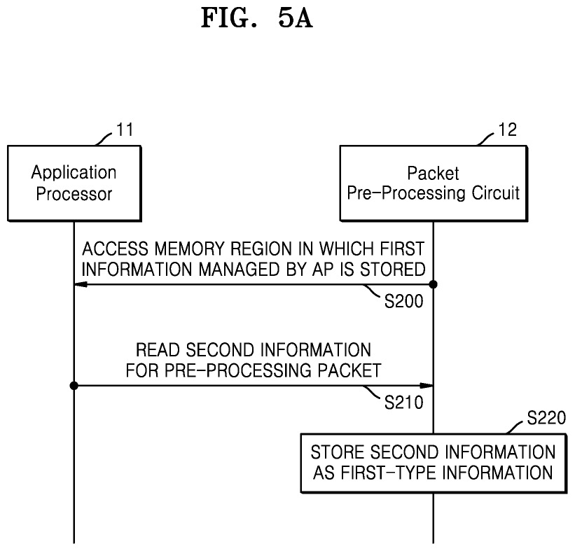

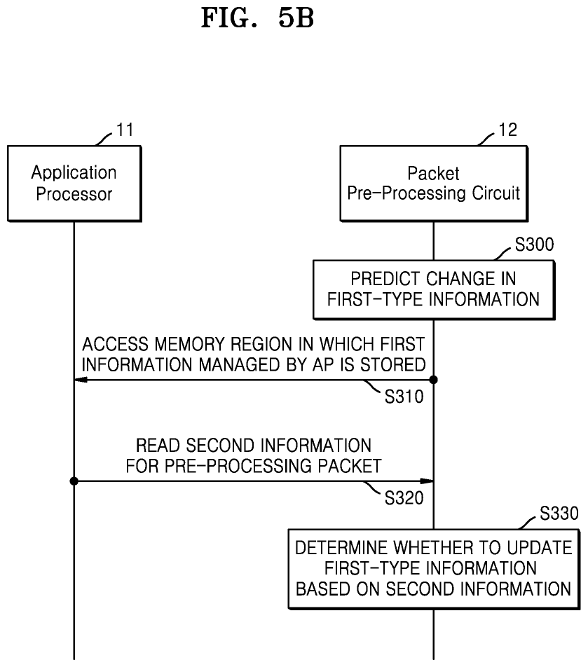

FIG. 5A is a flowchart for explaining a method of storing first-type information in the packet pre-processing circuit 12 according to an embodiment, and FIG. 5B is a flowchart a method of updating the first-type information in the packet pre-processing circuit 12 according to an embodiment.

Referring to FIG. 5A, in operation S200, the method may include performing an operation to access a memory region in which first information managed by the application processor 11 is stored. For example, the packet pre-processing circuit 12 may access a memory region in which first information managed by the application processor 11 is stored.

In operation S210, the method may include reading second information for pre-processing a packet from the first information. For example, the packet pre-processing circuit 12 may read second information for pre-processing a packet from the first information. In operation S220, the method may include reading second information for pre-processing a packet from the first information. For example, the packet pre-processing circuit 12 may store the second information read in operation S210 as the first-type information.

However, the disclosure is not limited to the embodiment illustrated in FIG. 5A. As such, according to another embodiment, the method may include variations to the illustrated features in FIG. 5A. For example, according to another embodiment, the packet pre-processing circuit 12 may directly request the second information from the application processor 11 or receive the second information from the application processor 11.

Further referring to FIG. 5B, in operation S300, the method may include predicting a change in the first-type information. For example, the packet pre-processing circuit 12 may predict a change in the first-type information. In an embodiment, the packet pre-processing circuit 12 may predict the first-type information based on previous first-type information. In a specific example, the packet pre-processing circuit 12 may predict a change in the state of the application processor 11, for example, a transition from the power saving mode to the normal mode.

In operation S310, the method may include performing an operation to access a memory region in which first information managed by the application processor 11 is stored. For example, the packet pre-processing circuit 12 may access a memory region in which first information managed by the application processor 11 is stored.

In operation S320, the method may include read second information for pre-processing a packet from the first information. For example, the packet pre-processing circuit 12 may read second information for pre-processing a packet from the first information.

In operation S330, the method may include determining whether to update the first-type information based on the second information. For example, the packet pre-processing circuit 12 may determine whether to update the first-type information based on the second information. That is, the packet pre-processing circuit 12 may check, through the second information, whether the change in the first-type information predicted in operation S300 has actually occurred and may determine whether to update the first-type information based on the checked result. In a case in which the application processor 11 actually switches from the power saving mode to the normal mode, the packet pre-processing circuit 12 may update the first-type information to indicate that the application processor 11 is currently operating in the normal mode.

However, the disclosure is not limited to the embodiment illustrated in FIG. 5B. As such, according to another embodiment, the method may include variations to the illustrated features in FIG. 5B. For example, according to another embodiment, the packet pre-processing circuit 12 may receive changed second information from the application processor 11 periodically or aperiodically.

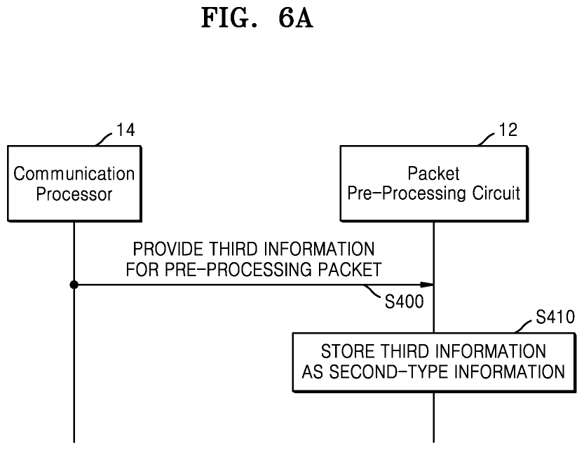

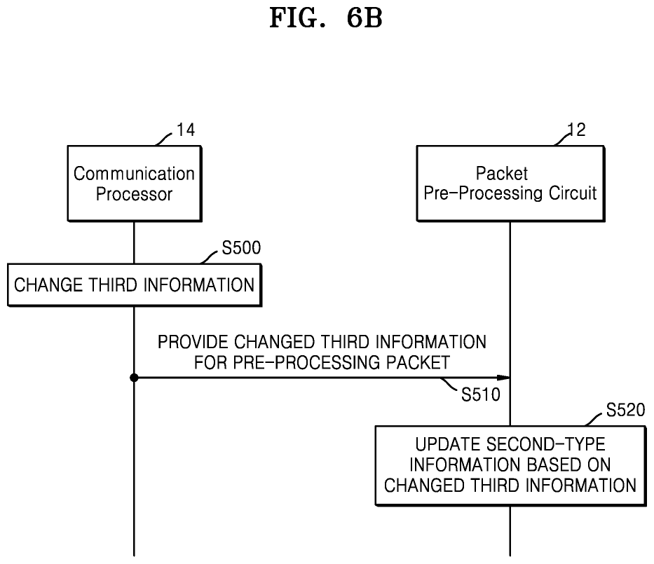

FIGS. 6A and 6B are flowcharts for explaining a method of storing second-type information and a method of updating the second-type information, respectively, in the packet pre-processing circuit 12 according to an embodiment.

Referring to FIG. 6A, in operation S400, the method may include providing the packet pre-processing circuit 12 with third information for pre-processing a packet. For example, the communication processor 14 may provide the packet pre-processing circuit 12 with third information for pre-processing a packet.

In operation S410, the method may include storing the third information received from the communication processor 14 as the second-type information. For example, the packet pre-processing circuit 12 may store the third information received from the communication processor 14 as the second-type information.

However, this is only an example, and the embodiment is not limited thereto. As such, according to another embodiment, the packet pre-processing circuit 12 may directly request the third information from the communication processor 14 or access a memory region in which information managed by the communication processor 14 is stored.

Referring further to FIG. 6B, the communication processor 14 may change the third information in operation S500.

In operation S510, the method may include providing the packet pre-processing circuit 12 with the changed third information for pre-processing the packet. For example, the communication processor 14 may provide the packet pre-processing circuit 12 with the changed third information for pre-processing the packet.

In operation S520, the method may include updating the second-type information based on the changed third information. For example, the packet pre-processing circuit 12 may update the second-type information based on the changed third information.

However, this is only an example, and the embodiment is not limited thereto. The packet pre-processing circuit 12 may directly request the changed third information from the communication processor 14 periodically or aperiodically.

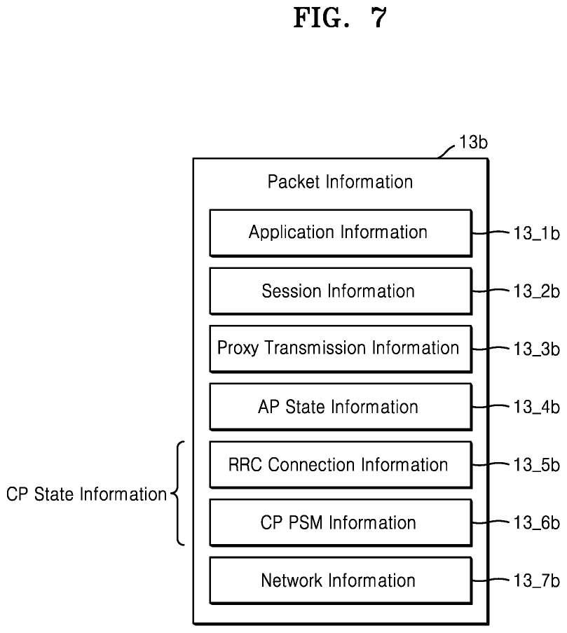

FIG. 7 is a diagram for explaining packet information 13b according to an embodiment.

Referring to FIG. 7, the packet information 13b may include application information 13_1b, session information 13_2b, proxy transmission information 13_3b, AP state information 13_4b, radio resource control (RRC) connection information 13_5b, CP power saving mode (PSM) information 13_6b, and network information 13_7b.

In an embodiment, the application information 13_1b may include information about the importance and maximum possible delay time of each of a plurality of applications executed by the application processor. The importance of each of the applications may be a criterion for the packet pre-processing circuit to determine any one of the second to fourth policies described above as the pre-processing policy for the packet instead of the first policy described above, and the maximum possible delay time may be a criterion for determining the delay time in the second policy described above.

In an embodiment, the session information 13_2b is to identify sessions related to received packets and may include at least one of IP/port information and TCP session information. The IP/port information may include a plurality of sets each including a port number, a remote IP address, and an IP address of an application processor for each session. The TCP session information may include a plurality of sets each including a port number, an IP address, and a TCP session state for each session.

In an embodiment, the proxy transmission information 13_3b may include information that is necessary for a packet pre-processing circuit to generate a response packet on behalf of a specific processor that is a destination processor of a packet. For example, the proxy transmission information 13_3b may include a valid IP address in DNS so that a packet pre-processing circuit related to the DNS generates a response packet to a DNS query. In another example, the proxy transmission information 13_3b may include information about TCP in order to generate an ‘rst’ packet in response to a packet that is received when the state of the TCP session is in a specific state (a ‘fin’ state or an ‘rst’ state).

In an embodiment, the AP state information 13_4b may include information that indicates an operation mode of an application processor. For example, the AP state information 13_4b may include information that indicates whether an application processor is operating in a power saving mode (or an idle state).

In an embodiment, the RRC connection information 13_5b may include information indicating an RRC connection state, information about an idle state and a timer that counts the time of the idle state, information about the timer for entering the idle state, and the like. In an embodiment, the packet pre-processing circuit may determine a delay time in the second policy described above, based on at least one of the information about the timer for counting the time in the idle state and the information about the timer for entering the idle state.

In an embodiment, the CP PSM information 13_6b may include information indicating whether a communication processor is operating in a power saving mode and information about a timer (e.g., a T3412 timer) associated with a PSM mode of the communication processor. In an embodiment, the packet pre-processing circuit may determine the delay time in the second policy described above based on the information about the timer related to the PSM mode.

According to an embodiment of the disclosure, the RRC connection information 13_5b and the CP PSM information 13_6b may be defined as CP state information.

In an embodiment, the network information 13_7b may include information indicating the type of network that is currently connected to an electronic device. In an embodiment, the network information 13_7b may indicate whether the current network includes a network related to satellite communication.

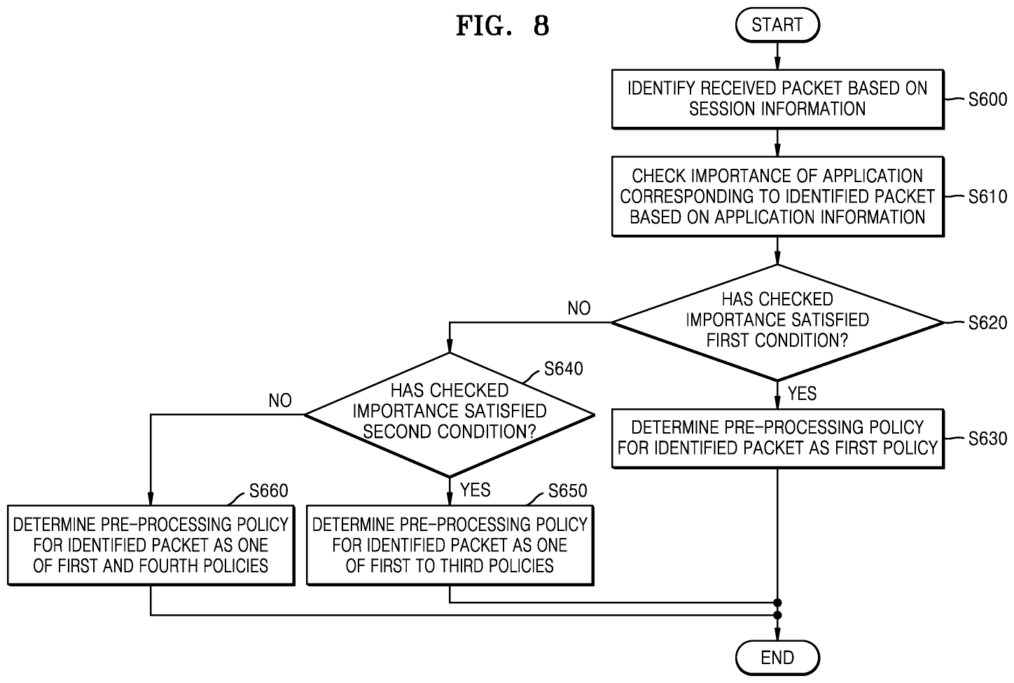

FIG. 8 is a flowchart for explaining a method of operating a packet pre-processing circuit, according to an embodiment. Although FIG. 8 illustrates an example in which the second to fourth policies are used to determine the pre-processing policy, this is only an example and the embodiment is not limited thereto. For example, only some of the second to fourth policies may be used.

Referring to FIG. 8, in operation S600, the method may include identifying a received packet based on the session information included in the packet information. For example, the packet pre-processing circuit may identify a received packet based on the session information included in the packet information.

In operation 610, the method may include checking the importance of an application corresponding to the identified packet based on the application information included in the packet information. For example, the packet pre-processing circuit may check the importance of an application corresponding to the identified packet based on the application information included in the packet information.

In operation S620, the method may include determining whether the importance identified in operation S610 satisfies a first condition. For example, the packet pre-processing circuit may determine whether the importance identified in operation S610 satisfies a first condition. According to an embodiment of the disclosure, the first to second conditions may be preset to determine one of the first to fourth policies as the pre-processing policy. For example, the first condition represents a condition capable of identifying an application of which the importance is set higher than a threshold, and the first policy may be determined as the pre-processing policy so that packets of the application are always transmitted normally. In addition, the second condition represents a condition capable of identifying an application of which the importance is within a specific range, and either the second or third policy may be determined as the pre-processing policy in a situation in which power saving is required for packets of the application or in a network in which wireless resources are scarce. Finally, an application that does not satisfy the first and second conditions is identified as an application having very low importance, and the fourth policy may be determined as a pre-processing policy for packets of the application.

If ‘YES’ in operation S620, operation S630 may proceed. For example, the packet pre-processing circuit may determine the pre-processing policy for the identified packet as the first policy.

If ‘NO’ in operation S620, operation S640 may proceed. For example, the packet pre-processing circuit may determine whether the identified importance satisfies the second condition.

If ‘YES’ in operation S640, operation S650 may proceed. For example, the packet pre-processing circuit may determine the pre-processing policy for the identified packet as one of the first to third policies.

If ‘NO’ in operation S640, operation S660 may proceed. For example, the packet pre-processing circuit may determine the pre-processing policy for the identified packet as one of the first and fourth policies.

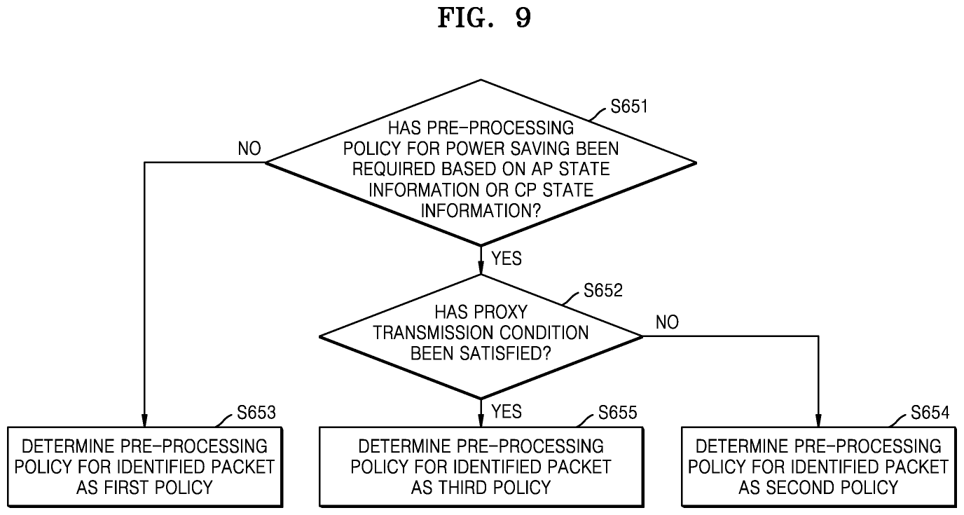

FIG. 9 is a flowchart for explaining a method of operating the packet pre-processing circuit in operation S650 of FIG. 8.

Referring to FIG. 9, in operation S651, the method may include determining whether a pre-processing policy for power saving is required, based on the AP state information or CP state information. For example, the packet pre-processing circuit may determine whether a pre-processing policy for power saving is required, based on the AP state information or CP state information.

If ‘YES’ in operation S651, operation S652 may proceed. For example, the packet pre-processing circuit may determine whether a proxy transmission condition is satisfied. In other words, the packet pre-processing circuit may determine whether the packet pre-processing circuit is capable of generating a response packet on behalf of a specific processor in response to a received packet.

If ‘NO’ in operation S651, operation S653 may proceed. For example, the packet pre-processing circuit may determine the pre-processing policy for the identified packet as the first policy for normal transmission.

If ‘NO’ in operation S652, operation S654 may proceed. For example, the packet pre-processing circuit may determine the pre-processing policy for the identified packet as the second policy for delay transmission.

If ‘YES’ in operation S652, operation S655 may proceed. The packet pre-processing circuit may determine the pre-processing policy for the identified packet as the third policy for proxy transmission.

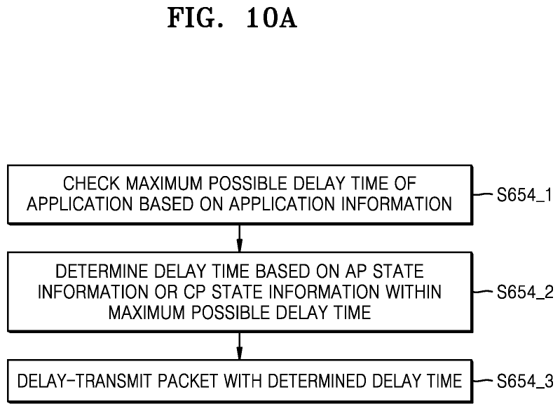

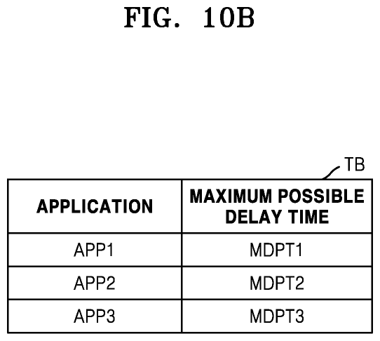

FIG. 10A is a flowchart for explaining a method of operating the packet pre-processing circuit in operation S654 of FIG. 9, and FIG. 10B is a table in which information referenced in an embodiment of FIG. 10A is listed.

Referring to FIG. 10A, in operation S654_1, the method may include checking the maximum possible delay time of the application corresponding to the identified packet, based on the application information in the packet information. For example, the packet pre-processing circuit may check the maximum possible delay time of the application corresponding to the identified packet, based on the application information in the packet information.

Referring further to FIG. 10B, the application information may include a table TB representing the maximum possible delay time that is set for each of applications. For example, a first maximum possible delay time MDPT1 may be set in a first application APP1, a second maximum possible delay time MDPT2 may be set in a second application APP2, and a third maximum possible delay time MDPT3 may be set in a third application APP3. The packet pre-processing circuit may check the maximum possible delay time of the application, which corresponds to the identified packet, with reference to the table TB.

In operation S654_2, the method may include determining the delay time in the second policy within the maximum possible delay time that has been checked in operation S654_1, based on the AP state information or CP state information included in the packet information. For example, the packet pre-processing circuit may determine the delay time in the second policy within the maximum possible delay time that has been checked in operation S654_1, based on the AP state information or CP state information included in the packet information.

In operation S654_3, the method may include transmitting the identified packet to a destination for the identified packet with the delay time that has been determined in operation S654_2. For example, the packet pre-processing circuit may delay-transmit the identified packet to a destination for the identified packet with the delay time that has been determined in operation S654_2.

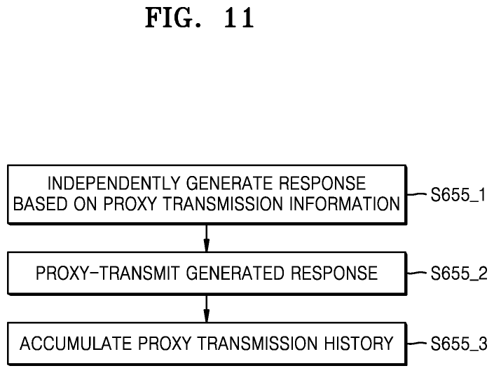

FIG. 11 is a flowchart for explaining a method of operating the packet pre-processing circuit in operation S655 of FIG. 9.

Referring to FIG. 11, in operation S655_1, the method may include generating a response based on proxy transmission information included in the packet information. For example, the packet pre-processing circuit may independently generate a response based on proxy transmission information included in the packet information.

In operation S655_2, the method may include proxy-transmit the response (or the response packet) generated in operation S655_1. For example, the packet pre-processing circuit may proxy-transmit the response (or the response packet) generated in operation S655_1.

In operation S655_3, the method may include accumulating a proxy transmission history. For example, the packet pre-processing circuit may accumulate a proxy transmission history. The proxy transmission history may be provided to a specific processor when necessary.

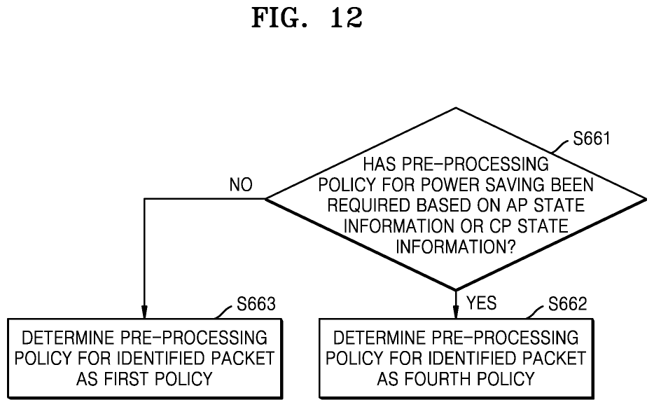

FIG. 12 is a flowchart for explaining a method of operating the packet pre-processing circuit in operation S660 of FIG. 8.

Referring to FIG. 12, in operation S661, the method may include determining whether a pre-processing policy for power saving is required, based on the AP state information or CP state information. For example, the packet pre-processing circuit may determine whether a pre-processing policy for power saving is required, based on the AP state information or CP state information.

If ‘YES’ in operation S661, operation S662 may proceed. For example, the packet pre-processing circuit may determine the pre-processing policy for the identified packet as the fourth policy.

If ‘NO’ in operation S661, operation S663 may proceed. For example, the packet pre-processing circuit may determine the pre-processing policy for the identified packet as the first policy.

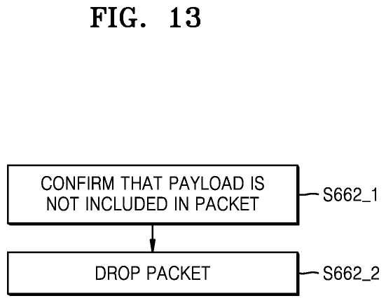

FIG. 13 is a flowchart for explaining a method of operating the packet pre-processing circuit in operation S662 of FIG. 12.

Referring to FIG. 13, in operation S662_1, the method may include confirming that the packet does not include a payload. For example, the packet pre-processing circuit may confirm that the packet does not include a payload.

In operation S662_2, the method may include dropping the packet based on the result confirmed in operation S662_1. For example, the packet pre-processing circuit may drop the packet based on the result confirmed in operation S662_1.

Also, when confirming that a packet includes a payload, the packet pre-processing circuit may pass the packet without dropping the packet and then transmit the packet to the destination normally.

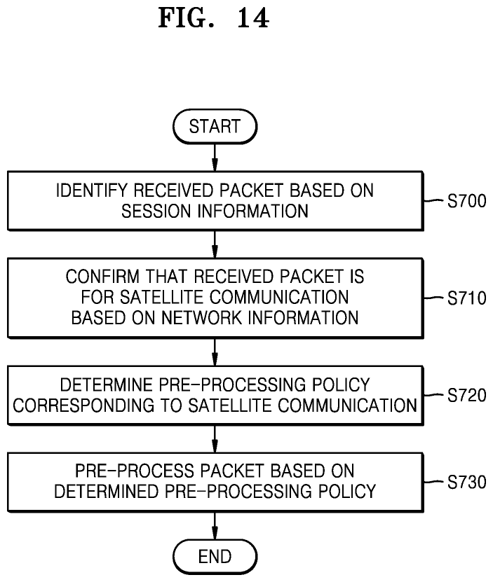

FIG. 14 is a flowchart for explaining a method of operating the packet pre-processing circuit, according to an embodiment.

Referring to FIG. 14, in operation S700, the method may include identifying a received packet based on the session information included in the packet information. For example, the packet pre-processing circuit may identify a received packet based on the session information included in the packet information.

In operation S710, the method may include confirming that the received packet is for satellite communication based on the network information included in the packet information. For example, the packet pre-processing circuit may confirm that the received packet is for satellite communication based on the network information included in the packet information.

In operation S720, the method may include determining a pre-processing policy corresponding to the satellite communications. For example, the packet pre-processing circuit may determine a pre-processing policy corresponding to the satellite communications. For example, the packet pre-processing circuit may determine the second policy for delay transmission as a pre-processing policy for the received packet. Also, the packet pre-processing circuit may determine the delay time in the second policy so as to correspond to network characteristics for satellite communication.

In operation S730, the method may include-processing the received packet based on the pre-processing policy determined in operation S720. For example, the packet pre-processing circuit may pre-process the received packet based on the pre-processing policy determined in operation S720.

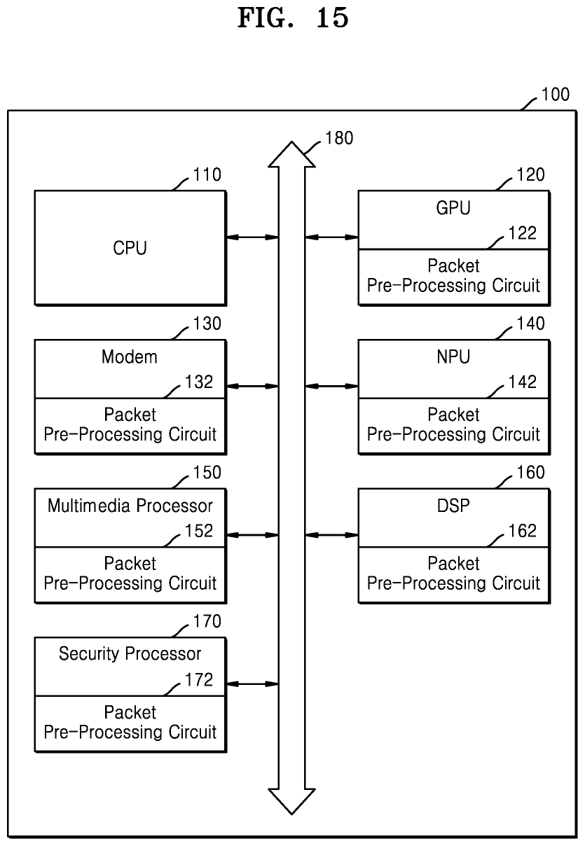

FIG. 15 is a block diagram schematically illustrating a mobile AP according to an embodiment.

Referring to FIG. 15, a mobile AP 100 may include a central processing unit (CPU) 110, a graphics processing unit (GPU) 120, a modem 130, a neural processing unit (NPU) 140, a multimedia processor 150, a digital signal processor (DSP) 160, a security processor 170, and a bus 180. However, the mobile AP 100 may exclude some of the components described above or may further include one or more other components or intellectual properties (IP).

According to an embodiment of the disclosure, the CPU 110 may be referred to as a main IP, and each of the GPU 120, the modem 130, the NPU 140, the multimedia processor 150, the DSP 160, and the security processor 170 may be referred to as an auxiliary IP.

The CPU 110 may execute a plurality of applications and transmit packets to and receive packets from, via the bus 180, at least one of the GPU 120, the modem 130, the NPU 140, the multimedia processor 150, the DSP 160, and the security processor 170.

The GPU 120 may include packet pre-processing circuit 122, the modem 130 may include packet pre-processing circuit 132, the NPU 140 may include packet pre-processing circuit 142, the multimedia processor 150 may include packet pre-processing circuit 152, the DSP 160 may include packet pre-processing circuit 162, and the security processor 170 may include packet pre-processing circuit 122, 132, 142, 152, 162, and 172 to which the embodiments described above in FIGS. 1 to 15 are applied.

In an embodiment, the packet pre-processing circuits 122, 132, 142, 152, 162, and 172 may determine either a policy for packet delay scheduling or a policy for adjusting the amount of packet transmission to a lower level as a pre-processing policy for bidirectionally received packets, based on the packet information. The packet pre-processing circuits 122, 132, 142, 152, 162, and 172 may pre-process the packets based on the determined pre-processing policy, and thus, the overall performance of the mobile AP 100 may be improved.

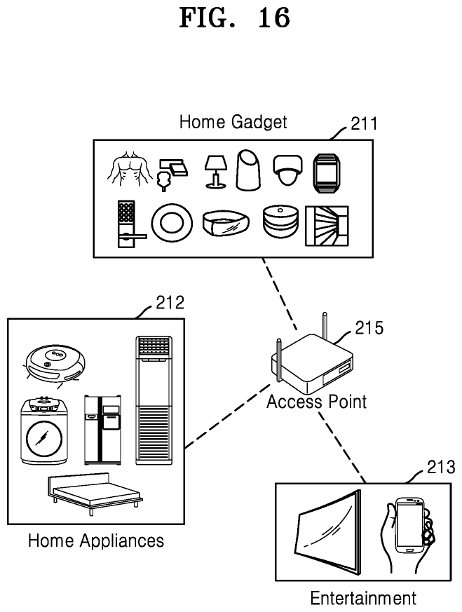

FIG. 16 is a view showing examples of devices for wireless communication according to an embodiment. For example, FIG. 16 shows an Internet of Things (IoT) network system that includes one or more home gadgets 211, one or more home appliances 212, one or more entertainment devices 213, and an access point 215.

As described above with reference to FIGS. 1 to 15, the devices of FIG. 16 for wireless communication may include packet pre-processing circuits and adaptively determine pre-processing policies for packets in order to prevent unnecessary power consumption of the devices or efficiently use wireless resources. Accordingly, it is possible to improve the overall communication performance of the devices for wireless communication.

While the disclosure has been particularly shown and described with reference to embodiments thereof, it will be understood that various changes in form and details may be made therein without departing from the spirit and scope of the following claims.

What is claimed is:

1. An electronic device comprising:
a plurality of processors; and
a packet pre-processing circuit configured to:
determine a pre-processing policy, from among a plurality of policies, for a packet transmitted from a first processor, among plurality of processors, to a second processor, among the plurality of the processors based on packet information related to the first processor and the second processor, and
perform a pre-processing operation on the packet based on the determined pre-processing policy.

2. The electronic device of claim 1, wherein the plurality of policies comprise:
a first policy in which the pre-processing operation of the packet by the packet pre-processing circuit is bypassed and the packet is transmitted to the second processor;
a second policy in which the packet is transmitted with a delay to the destination processor;
a third policy in a which a response with respect to the packet is proxy-transmitted on behalf of the destination processor; and
a fourth policy in which the packet is dropped.

3. The electronic device of claim 2, wherein the packet pre-processing circuit is configured to determine, based on the packet information, that the destination processor is operating in a power saving mode and determine one of the second policy, the third policy or the fourth policies as the pre-processing policy.

4. The electronic device of claim 2, wherein the packet pre-processing circuit in the second policy is configured to determine a delay time for the packet based on the packet information.

5. The electronic device of claim 2, wherein, in the second policy, the packet pre-processing circuit is further configured to store the packet in a packet pending queue.

6. The electronic device of claim 2, wherein n the third policy, the packet pre-processing circuit is further configured to:
a response generator configured to generate the response based on response information contained in the packet information; and
a loopback buffer configured to store the response to proxy-transmit the response to the source processor.

7. The electronic device of claim 2, wherein, in the third policy, the packet pre-processing circuit is further configured to accumulate a history of the proxy transmission and provide the history to the second processor.

8. The electronic device of claim 1, wherein the first processor is an application processor and the second processor is a communication processor, and
wherein the packet information comprises one of:
application information configured to indicate an importance level of an application corresponding to the packet;
session information configured to identify a session corresponding to the packet;
proxy transmission information configured to generate a response corresponding to the packet;
first state information configured to indicate a state of the application processor;
second state information configured to indicate a state of the communication processor; or
network information configured to indicate a network corresponding to the packet.

9. The electronic device of claim 8, wherein the second state information comprises:
radio resource control (RRC) connection information configured to indicate a connection state of RRC; and
power saving mode (PSM) information configured to indicate whether the communication processor operates in a power saving mode.

10. The electronic device of claim 8, wherein the packet pre-processing circuit is further configured to acquire, from the application processor, first-type information that comprises at least one of the application information, the session information, the proxy transmission information, or the first state information, and
acquire, from the communication processor, second-type information that comprises one of the second state information or the network information.

11. The electronic device of claim 10, wherein the packet pre-processing circuit is further configured to actively update the first-type information by accessing the application processor and to passively update the second-type information depending on the communication processor.

12. The electronic device of claim 1, wherein the first processor is an application processor and the second processor is a communication processor, and
the packet pre-processing circuit is further configured to enable bidirectional pre-processing operations for a first packet and a second packet,
wherein a source processor of the first packet is the application processor and a destination processor of the first packet is the communication processor, and a source processor of the second packet is the communication processor and a destination processor of the second packet is the application processor.

13. The electronic device of claim 1, wherein the packet pre-processing circuit is further configured to be separated from the first and the second processors.

14. The electronic device of claim 1, wherein the packet pre-processing circuit is configured to be integrated with one of the first and the second processors.

15. The electronic device of claim 1, wherein the plurality of processors comprise at least two of an application processor, a communication processor, a neural network processor, a digital signal processor, and a graphics processor.

16. A first electronic device comprising:
a communication processor configured to perform data processing for communication with a second electronic device based on a network established between the first electronic device and the second electronic device;
an application processor configured to transmit a first packet, which is generated based on a first application, to the communication processor; and
a packet pre-processing circuit configured to:
determine a first pre-processing policy for the first packet based on an importance level of the first application and a state of the communication processor, and
perform a pre-processing operation on the first packet based on the determined first pre-processing policy.

17. The first electronic device of claim 16, wherein the packet pre-processing circuit is further configured to determine whether power saving for the communication processor is required, based on the importance level of the first application satisfying a first condition and the communication processor is in a radio resource control (RRC) idle state or operates in the power saving mode,
wherein the first pre-processing policy comprises one of a first policy of delay-transmitting the first packet to the first destination processor, a second policy of proxy-transmitting a response with respect to the first packet on behalf of the first destination processor, and a third policy of dropping the first packet.

18. The first electronic device of claim 16, wherein the packet pre-processing circuit is further configured to determine, as the first pre-processing policy, a policy of delay-transmitting the first packet to the first destination processor based on the network, when the network relates to satellite communication.

19. The first electronic device of claim 16, wherein the communication processor is configured to transmit a second packet, which is generated by performing the data processing, to the application processor as a second destination processor,
wherein the packet pre-processing circuit is further configured to:
determine whether power saving for the application processor is required based on the importance level of a second application corresponding to the second packet and a state of the application processor,
determine a second pre-processing policy for the second packet based on a determined result, and
perform a pre-processing operation on the second packet based on the determined second pre-processing policy.

20. An electronic device comprising:
a plurality of intellectual properties (IPs); and
a packet pre-processing circuit configured to perform a pre-processing operation on a packet that is transmitted from a first IP, among the plurality of IPs to a second IP, among the plurality of IPs based on packet information related to at least one of the first IP and the second IP,
wherein the pre-processing operation comprises one of a delay transmission operation, a proxy transmission operation, and a packet drop operation.
